(19) United States
(12) Patent Application Publication
(10) Pub. No.: US 2026/0325402 A1
(43) Pub. Date: Oct. 22, 2026

(54) MASSAGE DEVICE

(71) Applicant: COWAY Co., Ltd., Gongju-si (KR)

(72) Inventors: Yong Taek OH, Seoul (KR); Sang Woo KANG, Seoul (KR); Byung Soo YOON, Seoul (KR); Jeong Yeon KIM, Seoul (KR); Hyun Hee LEE, Seoul (KR); Min Wook PARK, Seoul (KR); Seong Hyun JIN, Seoul (KR)

(73) Assignee: COWAY Co., Ltd., Gongju-si (KR)

(21) Appl. No.: 19/709,748

(22) Filed: Jun. 16, 2026

Related U.S. Application Data
(63) Continuation of application No. PCT/KR2024/013378, filed on Sep. 5, 2024.

(30) Foreign Application Priority Data
Dec. 19, 2023 (KR) 10-2023-0185876
Mar. 20, 2024 (KR) 10-2024-0038696

(51) Int. Cl. A61H 37/00; A47C 17/16

(52) U.S. Cl. CPC A61H 37/00; A47C 17/16; A61H 2201/0142; A61H 2201/0149; A61H 2203/0425; A61H 2203/0443

(57) ABSTRACT

According to an aspect of the present disclosure, there may be provided a massage device including: a frame; a rotary platform supported rotatably about a rotation axis with respect to an upper side of the frame; a massage module provided on at least one of the frame and the rotary platform to massage a body of a user; a driving assembly providing a driving force for rotating the rotary platform; and a controller configured to control the massage module and the driving assembly based on a chair mode or a bed mode.

### TECHNICAL FIELD

The present disclosure relates to a massage device.

### BACKGROUND ART

Generally, a massage device provides physical stimulation or pressure to a whole body or a specific part of a body to promote blood circulation of body organs and facilitate metabolism, thereby relieving a tension state of muscles, to relieve physical and mental fatigue, helping with fatigue recovery, disease prevention, beauty care, and the like.

Furthermore, the massage device may be provided in a chair shape or a bed shape to allow a user to receive a massage while sitting or lying down. Furthermore, since an advantage provided in the chair shape and an advantage provided in the bed shape are different from each other, the massage device may be provided to be convertible between the chair shape and the bed shape. The massage device may include a plurality of platforms convertible into the chair shape and the bed shape, and a massage module massaging a body of the user.

In this regard, Korean Patent Application Publication No. 10-2023-0083011 of Ceragem Co., Ltd., entitled “Massage Device Capable of Switching Use States” (Patent Document 1), discloses a massage device including a backrest portion configured to switch between a first state in which a user receives a massage while sitting and a second state in which a user receives a massage while lying down.

However, the massage device of Patent Document 1 makes it difficult for the user to enter or dismount from the massage device through a side of the massage device, since a hinge part supporting the backrest such that the backrest is rotated about a hinge point is disposed higher than a first support surface or a second support surface. In other words, since an upper side of the hinge part of the massage device of Patent Document 1 is disposed higher than the first support surface or the second support surface, a body of the user may be caught on the hinge part when the user dismounts or enters through the side of the massage device, and thus the user typically enters or dismounts toward a front or a rear of the massage device. Furthermore, to dismount from the massage device in the second state, the user experiences an inconvenience in having to move to the front or the rear of the massage device in a seated posture after raising a body from a lying posture to the seated posture.

Furthermore, Korean Patent Application Publication No. 10-2022-0064633 “Massage Device” (Patent Document 2) of the present applicant discloses a massage device including a first platform, a second platform arranged rotatably with respect to the first platform, and a third platform arranged rotatably with respect to the second platform to be converted into a chair mode and a bed mode.

However, the massage device of Patent Document 2 has a problem in which a conversion into either the chair mode or the bed mode may not be performed while the user is seated. In other words, the second platform of the massage device of Patent Document 2 folds to an upper side of the first platform in the chair mode, and unfolds with respect to the first platform in the bed mode, so that the user may be supported by a chair seat surface in the chair mode, and be supported by a bed surface opposite to the chair seat surface in the bed mode. That is, the massage device of Patent Document 2 has a problem of requiring the user to dismount from the massage device to convert into the chair mode or the bed mode, because the chair seat surface supporting the user in the chair mode and the bed surface supporting the user in the bed mode are located on opposite sides of each other.

### PRIOR ART DOCUMENT

(Patent Document 1) Korean Patent Application Publication No. 10-2023-0083011 Published on Jun. 9, 2023
(Patent Document 2) Korean Patent Application Publication No. 10-2022-0064633 Published on May. 19, 2022

### DETAILED DESCRIPTION OF INVENTION

### Technical Problems

An embodiment of the present disclosure provides a massage device convertible into either a chair mode or a bed mode while a user is seated.

Furthermore, an embodiment of the present disclosure provides a massage device allowing the user to easily enter or dismount.

### Technical Solution

A massage device according to an aspect of the present disclosure includes: a frame; a rotary platform supported rotatably about a rotation axis with respect to an upper side of the frame; a massage module provided on at least one of the frame and the rotary platform to massage a body of a user; a driving assembly providing a driving force for rotating the rotary platform; and a controller configured to control the massage module and the driving assembly based on a chair mode or a bed mode, wherein the controller controls the driving assembly such that the rotary platform is rotated in an upward direction with respect to the frame to form a predetermined first angle with the frame in the chair mode, and is rotated in a downward direction with respect to the frame to form an angle larger than the predetermined first angle in the bed mode, and wherein the rotation axis is disposed lower than an upper surface of the rotary platform.

Further, the driving assembly may include: a driving cylinder expanding or contracting in a direction parallel to an extending direction of the frame; a transfer part sliding in a horizontal direction with respect to the frame according to an expansion or contraction of the driving cylinder; and one or more link parts connected to the transfer part and the rotary platform, and rotating the rotary platform by a transfer of the transfer part, wherein the one or more link parts rotate the rotary platform upwardly when the transfer part is transferred in one direction among directions parallel to the extending direction of the frame, and rotate the rotary platform downwardly when the transfer part is transferred in another direction among the directions parallel to the extending direction of the frame.

Further, the one or more link parts may include: a first link part rotatably connected to the transfer part and transferred together with the transfer part; and a second link part having one side connected to the rotary platform and the other side opposite to the one side rotatably connected to the first link part, and rotated about the one side by a transfer of the first link part to rotate the rotary platform, wherein the rotary platform and the second link part may rotate about the same center of rotation.

Further, the first link part may extend in a direction parallel to the extending direction of the frame, with at least a portion of the first link part sloping toward a lower portion of the frame.

Further, the one side of the first link part may be rotatably connected to the transfer part, the other side opposite to the one side of the first link part may be rotatably connected to the other side of the second link part, and the first link part and the second link part may rotate in the same direction by a movement of the transfer part.

Further, the rotary platform and the second link part may rotate while maintaining a predetermined third angle with respect to each other.

Further, the transfer part may be transferred in a direction away from the one side of the second link part when the driving cylinder expands, and be transferred toward the one side of the second link part when the driving cylinder contracts.

Further, the second link part may rotate the first link part in one direction to rotate the rotary platform upwardly when the transfer part is transferred in a direction away from the one side of the second link part, and rotate the first link part in another direction opposite to the one direction to rotate the rotary platform downwardly when the transfer part is transferred toward the one side of the second link part.

Further, the frame may include: a frame body supporting the rotary platform; and a guide part supported on a lower side of the frame body, extending in a direction parallel to the extending direction of the frame, and guiding the transfer of the transfer part, and the transfer part may include: a transfer body connected to the driving cylinder; and a coupling member disposed on a lower side of the transfer body and slidably engaged with the guide part.

Further, the guide part may include a plurality of guide parts spaced apart from each other in a perpendicular direction to the extending direction of the frame, and the transfer body may include: a transfer frame extending in the perpendicular direction from an inner side of the frame and connected to the driving cylinder; and a plurality of support frames disposed on both sides of the transfer frame, extending in a direction parallel to the extending direction of the frame, and disposed higher than the plurality of guide parts, and the coupling member may be disposed on a lower side of each of the plurality of support frames.

Further, the controller may drive the massage module in the bed mode, and control the driving assembly based on the chair mode when the massage module stops.

### Effect of Invention

A massage device according to an embodiment of the present disclosure allows a conversion into either the chair mode or the bed mode while the user is seated.

Furthermore, when expanding or contracting, a driving cylinder of the massage device is supported by a transfer part sliding in a front and rear direction, thereby preventing vibration in an up and down direction.

Furthermore, after a massage is finished, the massage device converts into the chair mode so that the user is placed in a seated state rather than a lying state, thereby allowing the user to easily dismount from the massage device.

Furthermore, since both ends of a second link part of the massage device are rotatably connected to the transfer part and a first link part, the first link part and a rotary platform may rotate about the same rotation axis.

Furthermore, since the rotation axis of the rotary platform is disposed lower than an upper surface of the rotary platform, the user may easily enter or dismount from the massage device through a side of the massage device.

### BRIEF DESCRIPTION OF THE DRAWINGS

FIG. 1 is a block diagram of a massage device according to an embodiment of the present disclosure.

FIG. 2 is a perspective view showing the massage device in a chair mode according to the embodiment of the present disclosure.

FIG. 3 is a perspective view showing the massage device in a bed mode according to the embodiment of the present disclosure.

FIG. 4 is a side view of the massage device of FIG. 2 viewed from a side.

FIG. 5 is a side view of the massage device of FIG. 3 viewed from the side.

FIG. 6 is a front view of the massage device of FIG. 2 viewed from a front of a frame.

FIG. 7 is an enlarged view enlarging part A of FIG. 6.

FIG. 8 is a bottom view of the massage device of FIG. 2 viewed from below.

FIG. 9 is a bottom view of the massage device of FIG. 3 viewed from below.

### MODE FOR IMPLEMENTING THE INVENTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, or ‘supported’ by another element, it should be understood that the element may be directly connected to, or flowed to another element, but that other elements may exist in the middle.

The terms used in the present disclosure are only used for describing specific embodiments, and are not intended to limit the present disclosure. Singular expressions include plural expressions unless the context clearly indicates otherwise.

Further, some components are exaggerated, omitted, or schematically illustrated in the accompanying drawings of the present specification, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a massage device 1 according to an embodiment will be described with reference to the drawings.

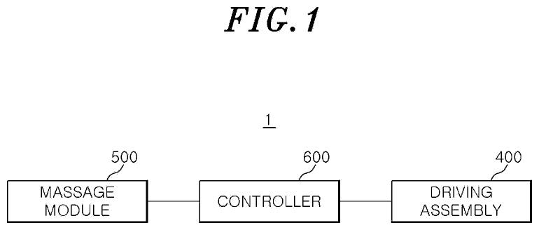

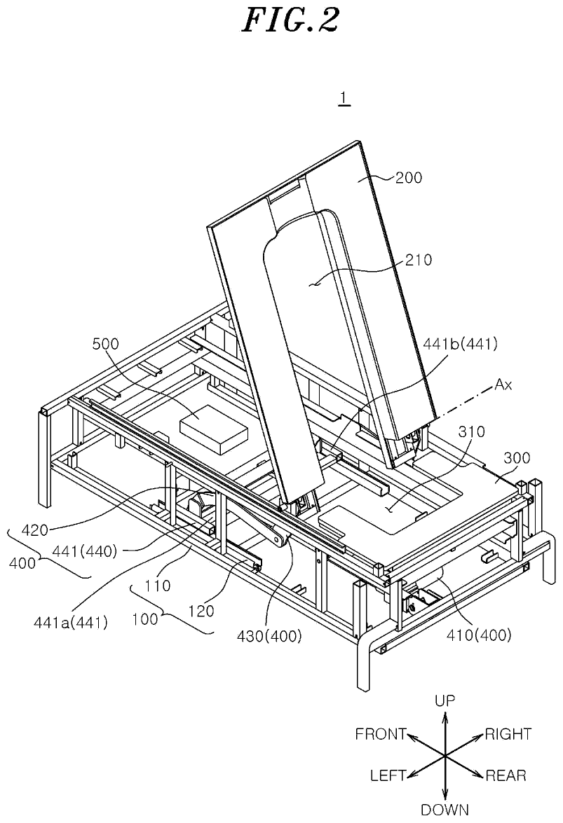

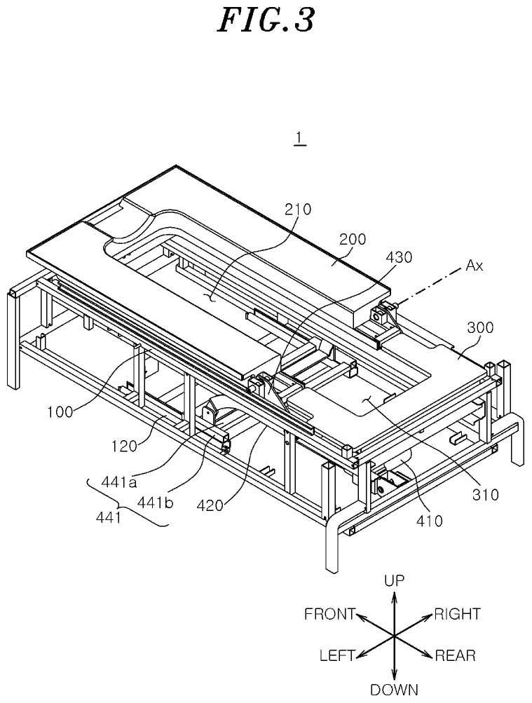

Referring to FIGS. 1 to 3, the massage device 1 may be provided in one or more of a bed mode, a chair mode, and a massage mode to support a user. The massage device 1 may support a head, a back, legs, and the like of the user so as to allow the user to lie on the massage device 1 in the bed mode, and may support the back, hips, thighs, and the like of the user so as to allow the user to sit on the massage device 1 in the chair mode. The massage mode is a mode for massaging the user supported on the massage device 1 by being performed when the massage device 1 is in the bed mode or the massage mode. Hereinafter, a direction toward which the head of the user faces when the user lies on the massage device 1 will be referred to as a front, and a direction toward which the legs of the user face will be referred to as a rear, but the present disclosure is not limited thereto, and the front may be one side, and the rear may be the other side opposite to the one side. The massage device 1 may include a frame 100, a rotary platform 200, a support platform 300, a driving assembly 400, a massage module 500, and a controller 600.

The frame 100 may support the rotary platform 200, the support platform 300, the driving assembly 400, the massage module, and the controller 600. Furthermore, the frame 100 may rotatably support the rotary platform 200. The frame 100 may include a frame body 110 and a guide part 120.

The frame body 110 may support the rotary platform 200, the support platform 300, and the driving assembly 400. Furthermore, the frame body 110 may support the rotary platform 200 such that the rotary platform 200 rotatably operates on an upper side. The frame body 110 may be formed such that a length in a front and rear direction is longer than a length in a left and right direction. Furthermore, a space accommodating the massage module 500 may be provided inside the frame body 110.

The guide part 120 may be supported on a lower side of the frame body 110 to guide a movement of a transfer part 440 of the driving assembly 400. The guide part 120 may extend in a direction parallel to an extending direction of the frame 100 such that the transfer part 440 is transferred in the front and rear direction. For example, the guide part 120 may be a rail extending in the front and rear direction. Furthermore, a plurality of guide parts 120 may be formed, and may be spaced apart from each other in the left and right direction to be disposed on an inner side of the frame body 110.

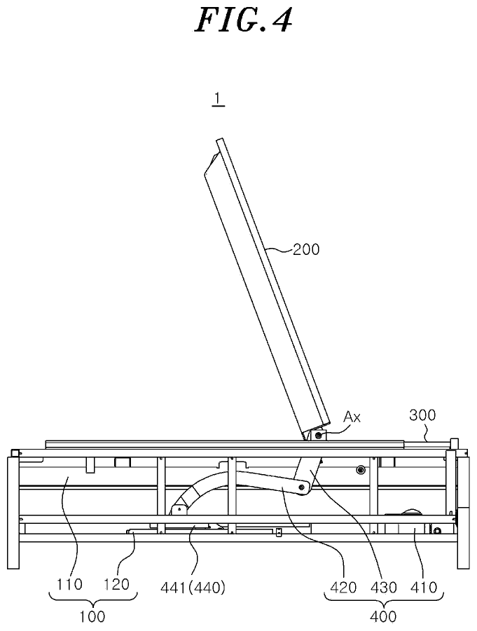

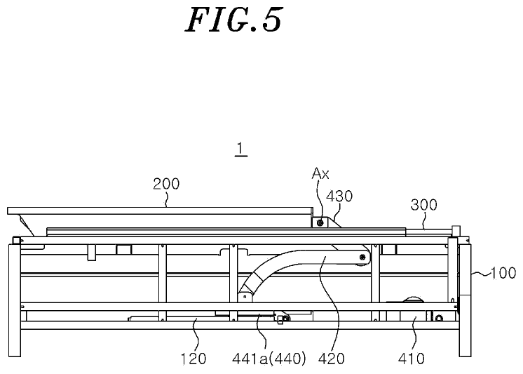

Further referring to FIGS. 4 and 5, the rotary platform 200 may be supported rotatably with respect to an upper side of the frame 100, and may support the body of the user. For example, the rotary platform 200 may support the head, a waist, and the like of the user. The rotary platform 200 may be rotated in an up and down direction about a rotation axis Ax extending in the left and right direction. The rotation axis Ax may be located on a rear side of the rotary platform 200 so as to be disposed lower than an upper surface of the rotary platform 200. The upper surface of the rotary platform 200 may be a surface facing the body of the user in the massage mode, the chair mode, and the bed mode.

The rotary platform 200 may have the rear side rotatably connected to the upper side of the frame body 110. Furthermore, the rear side of the rotary platform 200 may be located to a rear of the guide part 120.

The rotary platform 200 may be rotated in an upward direction with respect to the frame body 110 in the chair mode. Furthermore, the rotary platform 200, when in the chair mode, may be rotated in the upward direction with respect to the frame 100 to form a predetermined first angle with a rear portion of the frame 100. Furthermore, an angle formed by the rotary platform 200 and a virtual vertical plane perpendicular to the rotation axis Ax at the first angle may be formed smaller than an angle formed by the rotary platform 200 and the virtual vertical plane at a second angle to be described later. For example, the first angle may be 50 degrees or more and 90 degrees or less. In other words, the rotary platform 200 may be rotated in the chair mode such that a front side is disposed higher than the rear side.

Furthermore, the rotary platform 200 may be rotated in a downward direction with respect to the frame 100 in the bed mode. Furthermore, the rotary platform 200 may be rotated in the downward direction to form the second angle with the rear portion of the frame 100. The second angle may be formed larger than the first angle. In other words, the rotary platform 200 may be rotated with respect to the frame 100 to be placed horizontally in the bed mode. Furthermore, when the rotary platform 200 is in the bed mode, the rotation axis Ax may be located lower than the upper surface of the rotary platform 200.

A first opening 210 may be formed in the rotary platform 200. The first opening 210 may extend from the rear side toward the front side of the rotary platform 200. The first opening 210 may provide a space allowing the massage module to move.

The support platform 300 may be disposed on an upper side of the frame body 110 to support the body of the user. The support platform 300 may be spaced apart from the rotary platform 200 in the front and rear direction. Furthermore, the support platform 300 may be disposed to the rear of the rotary platform 200. Furthermore, in the bed mode, a length of the support platform 300 in the front and rear direction may be smaller than a length of the rotary platform 200 in the front and rear direction. For example, the support platform 300 may support the hips, thighs, legs, and the like of the user. Furthermore, a second opening 310 may be formed in the support platform 300. The second opening 310 may extend from a front side toward a rear side of the support platform 300 to provide a space allowing the massage module 500 to move in the massage mode. Furthermore, the second opening 310 may communicate with the first opening 210.

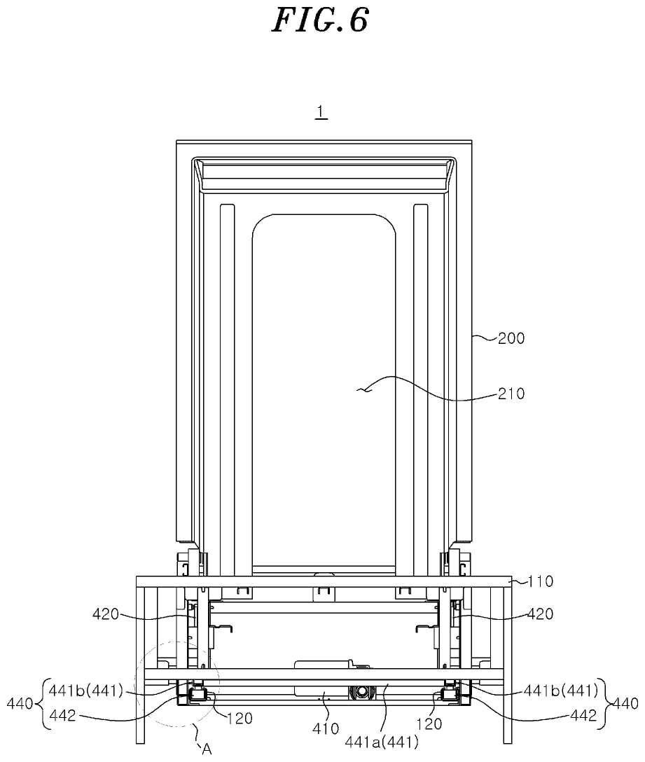

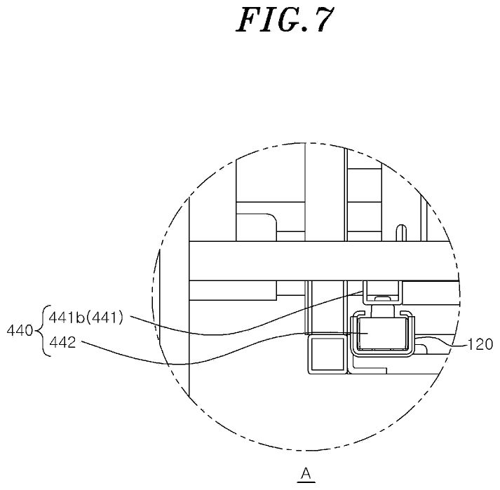

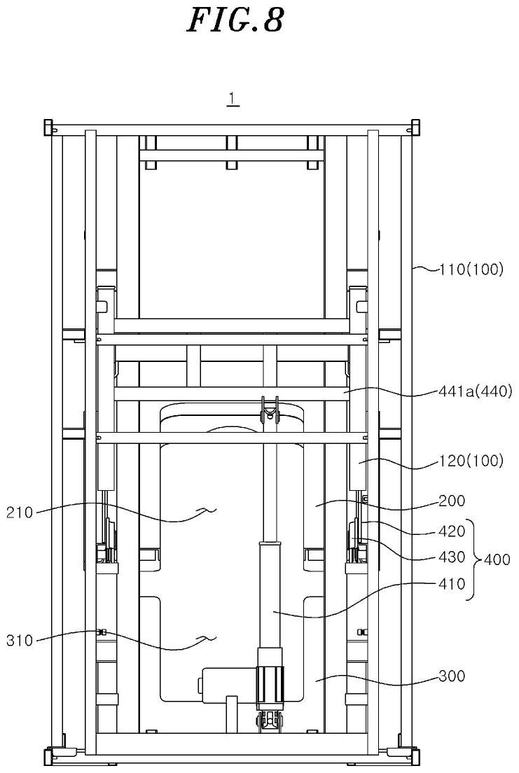

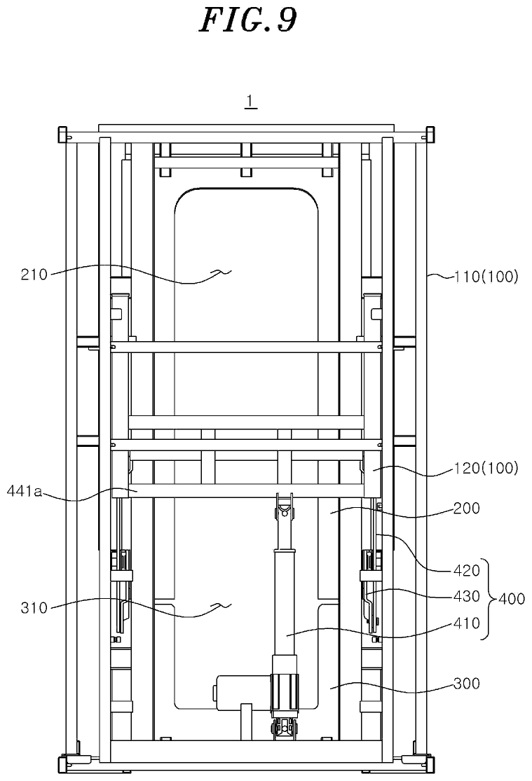

Further referring to FIGS. 6 to 9, the driving assembly 400 may provide a driving force for rotating the rotary platform 200. In other words, the driving assembly 400 may rotate the rotary platform 200 in the up and down direction such that the massage device 1 is converted into the chair mode, the bed mode, and the massage mode. The driving assembly 400 may include a driving cylinder 410, one or more link parts 420 and 430, and a transfer part 440.

The driving cylinder 410 may be supported by the frame 100, connected to the transfer part 440, and may expand or contract. The driving cylinder 410 may expand or contract in a direction parallel to the extending direction of the frame 100. In other words, the driving cylinder 410 may expand or contract in the front and rear direction. The driving cylinder 410 may expand or contract in the front and rear direction to move the transfer part 440 in the front and rear direction. The driving cylinder 410 may be disposed on the lower side of the frame body 110 to expand toward the front. The driving cylinder 410 may contract to move the transfer part 440 rearward in the bed mode. Furthermore, the driving cylinder 410 may expand to move the transfer part 440 forward in the chair mode. Furthermore, a front end of the driving cylinder 410 may be located to a front of the rotation axis Ax of the rotary platform 200 in the chair mode.

The one or more link parts 420 and 430 may connect the transfer part 440 and the rotary platform 200. The one or more link parts 420 and 430 may rotate the rotary platform 200 upwardly when the transfer part 440 is transferred forward. Furthermore, the one or more link parts 420 and 430 may rotate the rotary platform 200 downwardly when the transfer part 440 is transferred rearward. The one or more link parts 420 and 430 may include a first link part 420 and a second link part 430.

The first link part 420 may extend in the front and rear direction to have one side rotatably connected to the transfer part 440, and the other side opposite to the one side rotatably connected to the second link part 430. Furthermore, the first link part 420 may be moved in the front and rear direction together with the transfer part 440 when the transfer part 440 is moved in the front and rear direction. The first link part 420 may be disposed further rearward in the bed mode than in the chair mode. The other side of the first link part 420 may be disposed lower in the chair mode than in the bed mode. The other side of the first link part 420 may be disposed higher than the one side. Furthermore, a portion of the first link part 420 may be formed to be inclined toward the rear as it goes toward the other side of the first link part 420. In other words, the first link part 420 may extend in a direction parallel to the extending direction of the frame 100, and at least a portion thereof may be formed to slope toward a lower portion of the frame 100. Furthermore, a plurality of first link parts 420 may be formed to be connected to both sides of the transfer part 440.

The second link part 430 may rotate the rotary platform 200 by a movement of the first link part 420. One side of the second link part 430 may be rotatably connected to the rotary platform 200, and the other side opposite to the one side may be rotatably connected to the other side of the first link part 420. Furthermore, the second link part 430 may be rotated together with the rotary platform 200 about the rotation axis Ax. The second link part 430 and the rotary platform 200 may be rotated together forming a predetermined third angle with respect to each other. For example, the third angle may be formed to be larger than the first angle and smaller than the second angle. The second link part 430 may be arranged such that the one side is disposed to a front of the other side in the bed mode. The second link part 430 may be arranged such that the one side is disposed to a rear of the other side in the chair mode.

Furthermore, the one side of the second link part 430 may be located higher than the other side. By the second link part 430, the other side of the first link part 420 may be moved downward when the transfer part 440 is transferred forward, and may be moved upward when the transfer part 440 is moved rearward. Furthermore, the second link part 430 and the first link part 420 may rotate in the same direction by a movement of the transfer part 440. Since the second link part 430 and the first link part 420 may be rotated in the same direction according to the movement of the transfer part 440, the rotary platform 200 may be rotated in the up and down direction. In other words, when the second link part 430 is rotated in one direction about the rotation axis Ax, the first link part 420 may also be rotated in the one direction about the transfer part 440. Furthermore, when the second link part 430 is rotated in another direction about the rotation axis Ax, the first link part 420 may also be rotated in the other direction about the transfer part 440. Furthermore, a plurality of second link parts 430 may be formed to be connected to both sides of a rear end of the rotary platform 200, and connected to inner sides of the plurality of first link parts 420.

The transfer part 440 may be slidably moved with respect to the frame 100 according to an expansion or contraction of the driving cylinder 410 while being supported by the guide part 120. The transfer part 440 may be moved rearward by a contraction of the driving cylinder 410 in the bed mode. Furthermore, the transfer part 440 may be transferred toward the one side of the second link part 430 when the driving cylinder 410 contracts. The transfer part 440 may be moved forward by an expansion of the driving cylinder 410 in the chair mode. Furthermore, the transfer part 440 may move away from the one side of the second link part 430 when the driving cylinder 410 expands. The transfer part 440 may include a transfer body 441 and a coupling member 442.

The transfer body 441 may be disposed on the inner side of the frame body 110 to be connected to the driving cylinder 410. Furthermore, the transfer body 441 may rotatably support the one side of the first link part 420. The transfer body 441 may be moved forward to move the first link part 420 forward, and may be moved rearward to move the first link part 420 rearward. Furthermore, the transfer body 441 may include a transfer frame 441a and a plurality of support frames 441b.

The transfer frame 441a may extend in the left and right direction from an inner side of the frame 100 to be connected to the driving cylinder 410. Furthermore, the transfer frame 441a may support the plurality of support frames 441b. The transfer frame 441a may be moved in the front and rear direction by an expansion or contraction of the driving cylinder 410.

Each of the plurality of support frames 441b may be disposed on both sides of the transfer frame 441a to extend in the front and rear direction, and may be located higher than the guide part 120. Furthermore, the plurality of support frames 441b may support the coupling member 442.

The coupling member 442 may be disposed on a lower side of the transfer body 441, and may be engaged with the guide part 120 to be moved along an extending direction of the guide part 120. In other words, the coupling member 442 may be disposed on lower sides of the plurality of support frames 441b and be guided by the guide part 120 to guide the transfer body 441 in the front and rear direction. For example, the coupling member 442 may be a transfer pad inserted into the rail.

The massage module 500 may be provided on one or more of the frame 100, the rotary platform 200, and the support platform 300, and may massage the body of the user. As a first example, the massage module may massage the body of the user supported by one or more of the rotary platform 200 and the support platform 300 in the frame 100. In other words, the massage module, in the massage mode, may be moved in the front and rear direction in the frame 100 to press the body of the user. As a second example, the massage module may be moved in the front and rear direction in the first opening 210 and the second opening 310 in the massage mode. In other words, when the massage device 1 is in the massage mode, the massage module may be moved from the first opening 210 toward the second opening 310 or from the second opening 310 toward the first opening 210, massaging the body of the user. As a third example, the massage module may massage the body of the user in the first opening 210 when the massage device 1 is in the chair mode.

The controller 600 may control the driving assembly 400 and the massage module based on the chair mode, the bed mode, and the massage mode. In the bed mode, the controller 600 may control the driving cylinder 410 to contract the driving cylinder 410. In the bed mode, as the driving cylinder 410 contracts, the transfer part 440 and the first link part 420 may be moved rearward, and the second link part 430 and the rotary platform 200 may be rotated about the rotation axis Ax by a movement of the first link part 420, so that the rotary platform 200 may be rotated downwardly. By the controller 600, the rotary platform 200 may be disposed to form the second angle larger than the first angle with the frame 100 in the bed mode. The rotary platform 200 may be disposed horizontally with a ground or disposed to be inclined with respect to the frame 100 in the bed mode to form the second angle. Furthermore, the controller 600 may control the driving cylinder 410 such that the rotary platform 200 maintains the second angle with the frame 100 in the bed mode.

Furthermore, the controller 600 may control the driving cylinder 410 to expand the driving cylinder 410 in the chair mode. In the chair mode, as the driving cylinder 410 expands, the transfer part 440 and the first link part 420 may be moved forward, and the second link part 430 and the rotary platform 200 may be rotated about the rotation axis Ax by a movement of the first link part 420, so that the rotary platform 200 may be rotated upwardly. By the controller 600, the rotary platform 200 may be disposed to form the first angle with the frame 100 in the chair mode. Furthermore, the controller 600 may control the driving cylinder 410 such that the rotary platform 200 maintains the first angle with the frame 100 in the chair mode.

Furthermore, the controller 600 may drive the massage module in the massage mode. The controller 600 may perform the massage mode in the bed mode or the chair mode. Furthermore, the controller 600 may control the driving assembly 400 such that the massage device 1 is converted into the chair mode when the massage mode is finished after being performed in the bed mode. Since the massage device 1 converts into the chair mode after the massage mode is finished, the user may easily dismount from the massage device 1. In other words, when in the bed mode, the controller 600 may drive the massage module 500 based on the massage mode, and when the massage module 500 stops, control the driving assembly 400 based on the chair mode.

The above-described controller 600 may be implemented by a computing device including a microprocessor, a measuring device such as a sensor, and a memory, and since an implementation method thereof is obvious to a person skilled in the art, a more detailed description will be omitted.

Hereinafter, actions and effects of the massage device 1 according to an embodiment of the present disclosure will be described.

The massage device 1 according to an embodiment of the present disclosure may be placed in the chair mode before a use by the user, and when the user sits on the massage device 1 to receive a massage, the massage device 1 may convert into the massage mode or the bed mode. In other words, the controller 600 may control the driving assembly 400 such that the rotary platform 200 is rotated downwardly based on the bed mode. The controller 600 may dispose the massage module 500 in at least one of the first opening 210 and the second opening 310 based on the massage mode. Thereafter, when the massage mode is finished, the massage device 1 may convert into the chair mode to control the driving assembly 400 such that the rotary platform 200 forms the first angle with the frame 100.

Since the massage device 1 converts into the chair mode and the bed mode, the user may receive a massage while being in a seated state or a lying state on the massage device 1.

Furthermore, the massage device 1 may convert into the chair mode and the bed mode while the user is seated.

Furthermore, after the massage is finished, the massage device 1 converts into the chair mode so that the user may be placed in a seated state rather than a lying state, thereby allowing the user to easily dismount from the massage device 1.

Furthermore, when expanding or contracting, the driving cylinder 410 of the massage device 1 may be supported by the transfer part 440 sliding in the front and rear direction, thereby preventing a generation of vibration in a vertical direction.

Furthermore, since both ends of the second link part 430 of the massage device 1 may be rotatably connected to the transfer part 440 and the first link part 420, the first link part 420 and the rotary platform 200 may be rotated about the same rotation axis Ax.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

1. A massage device comprising:
a frame;
a rotary platform supported rotatably about a rotation axis with respect to an upper side of the frame;
a massage module provided on at least one of the frame and the rotary platform to massage a body of a user;
a driving assembly providing a driving force for rotating the rotary platform; and
a controller configured to control the massage module and the driving assembly based on a chair mode or a bed mode,
wherein the controller controls the driving assembly such that the rotary platform is rotated in an upward direction with respect to the frame to form a predetermined first angle with the frame in the chair mode, and is rotated in a downward direction with respect to the frame to form an angle larger than the predetermined first angle in the bed mode, and
wherein the rotation axis is disposed lower than an upper surface of the rotary platform.

2. The massage device of claim 1, wherein the driving assembly comprises:
a driving cylinder expanding or contracting in a direction parallel to an extending direction of the frame;
a transfer part sliding in a horizontal direction with respect to the frame according to an expansion or contraction of the driving cylinder; and
one or more link parts connected to the transfer part and the rotary platform, and rotating the rotary platform by a transfer of the transfer part,
wherein the one or more link parts rotate the rotary platform upwardly when the transfer part is transferred in one direction among directions parallel to the extending direction of the frame, and rotate the rotary platform downwardly when the transfer part is transferred in another direction among the directions parallel to the extending direction of the frame.

3. The massage device of claim 2, wherein the one or more link parts comprise:
a first link part rotatably connected to the transfer part and transferred together with the transfer part; and
a second link part having one side connected to the rotary platform and the other side opposite to the one side rotatably connected to the first link part, and rotated about the one side by a transfer of the first link part to rotate the rotary platform,
wherein the rotary platform and the second link part rotate about the same center of rotation.

4. The massage device of claim 3, wherein the first link part extends in a direction parallel to the extending direction of the frame, with at least a portion of the first link part sloping toward a lower portion of the frame.

5. The massage device of claim 3, wherein the one side of the first link part is rotatably connected to the transfer part, the other side opposite to the one side of the first link part is rotatably connected to the other side of the second link part, and the first link part and the second link part rotate in the same direction by a movement of the transfer part.

6. The massage device of claim 3, wherein the rotary platform and the second link part rotate while maintaining a predetermined third angle with respect to each other.

7. The massage device of claim 3, wherein the transfer part is transferred in a direction away from the one side of the second link part when the driving cylinder expands, and is transferred toward the one side of the second link part when the driving cylinder contracts.

8. The massage device of claim 7, wherein the second link part rotates the first link part in one direction to rotate the rotary platform upwardly when the transfer part is transferred in a direction away from the one side of the second link part, and rotates the first link part in another direction opposite to the one direction to rotate the rotary platform downwardly when the transfer part is transferred toward the one side of the second link part.

9. The massage device of claim 2, wherein the frame comprises:
a frame body supporting the rotary platform; and
a guide part supported on a lower side of the frame body, extending in a direction parallel to the extending direction of the frame, and guiding the transfer of the transfer part, and
wherein the transfer part comprises:
a transfer body connected to the driving cylinder; and
a coupling member disposed on a lower side of the transfer body and slidably engaged with the guide part.

10. The massage device of claim 9, wherein the guide part includes a plurality of guide parts spaced apart from each other in a perpendicular direction to the extending direction of the frame, and
wherein the transfer body includes:
a transfer frame extending in the perpendicular direction from an inner side of the frame and connected to the driving cylinder; and
a plurality of support frames disposed on both sides of the transfer frame, extending in a direction parallel to the extending direction of the frame, and disposed higher than the plurality of guide parts, and
wherein the coupling member is disposed on a lower side of each of the plurality of support frames.

11. The massage device of claim 1, wherein the controller drives the massage module in the bed mode, and controls the driving assembly based on the chair mode when the massage module stops.
